(19) United States
(12) Patent Application Publication
(10) Pub. No.: US 2011/0208585 A1
(43) Pub. Date: Aug. 25, 2011

(54) Systems and Methods for Measurement of Engagement

(76) Inventors: Peter Daboll, Los Gatos, CA (US); Hongpei Zhang, San Ramon, CA (US)

(21) Appl. No.: 12/709,161

(22) Filed: Feb. 19, 2010

(51) Int. Cl. G06Q 30/00; G06F 15/16

(52) U.S. Cl. 705/14.53; 709/224

(57) ABSTRACT

Exemplary systems and methods for measurement of engagement are provided. In various embodiments, a method coprises receiving business objectives of a web site or online publisher on a server, tracking user frequency and user activities for a predetermine time, computing and ranking engagement scores with the web site based on the tracked user frequency as a function of user action categories for the predetermined time and business objectives, the user action categories being associated with the user activities, segmenting users based the engagement scores, and directing an advertisement to a user of at least one user segment.

### BACKGROUND

1. Field of the Invention

Embodiments of the present invention are directed to measurement of engagement and more particularly to quantifying a user's engagement with a product or service.

2. Related Art

A brand or a web publisher, like any other business, has as an objective to create value or generate revenue. For example, a Proctor & Gamble brand campaign has the objectives of increasing brand awareness, purchase intent, likelihood to recommend, and favorability. In another example, an online e-tailer which receives revenue through purchases online would want to increase the number of site visitors that make an actual purchase. Still others, such as Facebook and Twitter, create value by gathering massive numbers of users through sharing of information.

Unfortunately, due to the sheer size of the Internet and the number of users, it is difficult to determine which users, or, more specifically, which actions or activities that users perform, are likely to generate value. For example, many users go online to get product reviews but only a few write a review. Given the current state of the art, businesses cannot determine which user or which user action (e.g., consuming or providing content) is more valuable to the business objective(s). Further, businesses cannot determine how much one user may be more valuable than another. As a result, brands and publishers do not have an insight to incent and promote valuable activities and actions that optimize their business objective (e.g., create value or generate revenue).

### SUMMARY OF THE INVENTION

Exemplary systems and methods for measurement of engagement are provided. In various embodiments, a method coprises receiving business objectives of a web site or online publisher on a server, tracking user frequency and user activities for a predetermined time, computing and ranking engagement scores with the web site based on the tracked user frequency as a function of user action categories for the predetermined time and business objectives, the user action categories being associated with the user activities, segmenting users based the engagement scores, and directing an advertisement or incentive for valuable actions to a user of at least one user segment.

In some embodiments, the at least one segment is of a plurality of user segments and the at least one segment has a higher correlation with business objectives than other user segments of the plurality of user segments. The tracking user activities may comprise tracking the frequency of user activities related to user action categories for the predetermined period of time. The user action categories may include a consume content category, a provided content category, a log in/register category, and a share information category, and a purchase/conversion/call-to-action category.

In various embodiments, generating engagement scores comprises performing regression analysis with tracked user frequency being a dependent variable and the different user action categories being different independent variables. Generating engagement scores may further comprise ranking regression coefficients for each of the user action categories. Further, generating engagement scores may comprise correlating user visit frequency to the business objective and such correlation may be used as weight in final engagement score.

The predetermined time may be 30 to 180 days. The method may further comprise customizing a customer loyalty program directed to at least one user segment based on engagement scores.

An exemplary system may comprise an input/output interface, a tracking module, an engagement module, a customizer module, and an application module. The input/output interface may be configured to receive business objectives of a web site on a web server. The tracking module may be configured to track user frequency and user activities for a predetermine time. The engagement module may be configured to compute and rank engagement scores with the web site based on tracked user frequency as a function of user action categories for the predetermined time and business objectives, the user action categories being associated with the user activities. The customizer module may be configured to segment users based on engagement scores. The application module may be configured to direct an advertisement to a user of at least one use segment.

An exemplary computer readable media may comprise executable instructions. The instructions may be executable by a processor to perform a method. The method may comprising receiving business objectives of a web site on a server, tracking user frequency and user activities for a predetermine time, computing and ranking engagement scores with the web site based on tracked user frequency as a function of user action categories for the predetermined time and business objectives, segmenting users based the engagement scores, and directing an advertisement to a user of at least one user segment.

### BRIEF DESCRIPTION OF THE DRAWINGS

FIG. 1 is a diagram of an environment in which embodiments of the present invention may be practiced.

FIG. 2 is a block diagram of an exemplary engagement server.

FIG. 3 is a flowchart of an exemplary method for increasing value based on user engagement.

FIG. 4 is a flowchart of an exemplary method for calculating an engagement score.

FIG. 5 is a flowchart of an exemplary method for improving revenue and value based on engagement score.

FIG. 6 is a block diagram of a digital device in which various embodiments may be practiced.

### DETAILED DESCRIPTION OF EXEMPLARY EMBODIMENTS

A quantitative engagement score for a visitor of a brand or online publisher web site may be used to measure existing users' engagement level or new users' likelihood to become engaged over a predetermined period of time. When generating engagement scores, user activities that are most apt to generate value/revenue may be identified. As a result, the engagement score may also measure users' likelihood of generating value and/or revenue.

Ultimately, systems and methods described herein may lead to an understanding of the correlation between the engagement score and business objectives. The engagement scores can be used to segment users and identify, incent, and promote site actions that achieve the site's objectives, and tailor differentiated product and marketing experience to different user segment. In various embodiments, system and methods described herein allow businesses the ability to score or measure engagement and to take action, in real time, to leverage and improve this score.

For example, engagement scores may be used to segment users to identify the most valuable users, general types of users, and the user activities that are most apt to generate value and/or revenue. Changes to products, services, and marketing may be made based on the engagement scores, users, types of users, and desirable user activities. For example, once the type of users that are prone to generate revenue and/or value are identified, targeted messaging may be provided to those users (e.g., email, text messages, messages in a web site, and advertising) to encourage actions most closely related to a business objective (e.g., making a sale). Further, based on the engagement scores and user segmentation, changes to brand web site(s), specific web pages, marketing, or products strategies may be made to appeal to the user that is most apt to provide revenue and/or value.

By identifying the users and the activities that are most apt to produce value, business decisions designed to generate revenue and profits may be made and evaluated. The process may be iterative and allow for businesses to measure the impact of decisions over time thereby providing a better experience for those users that take advantage of the web site services and content. Based on the engagement score, business owners may be able to make the right offer of the right product, at the right price to the right people and greatly increase return on the investment.

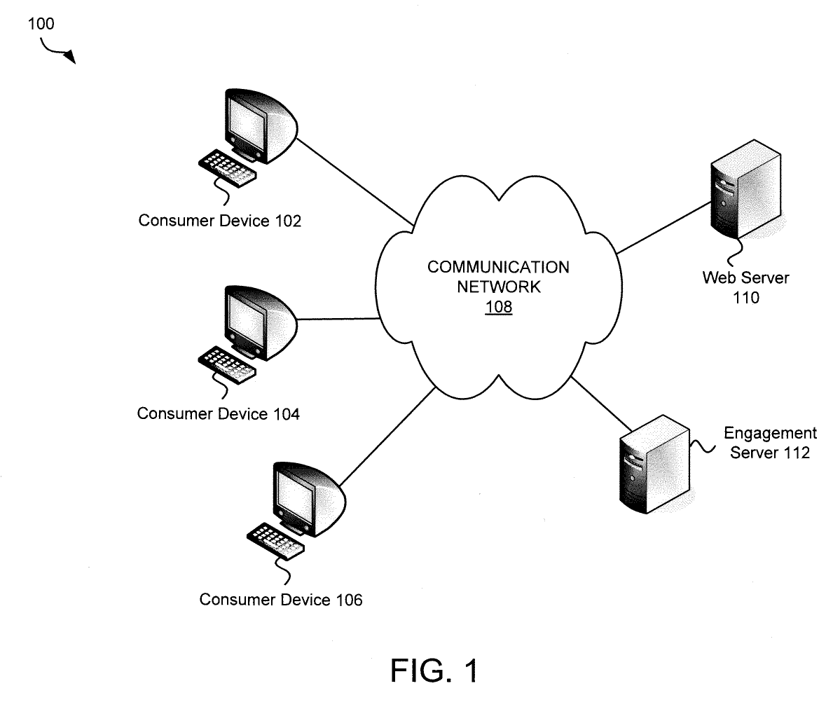

FIG. 1 is a diagram of an environment 100 in which embodiments of the present invention may be practiced. The environment 100 comprises consumer devices 102, 104, and 106, a communication network 108, a web server 110, and an optional engagement server 112. In various embodiments, the engagement of the consumer device 102 with a web site hosted by the web server 110 may be measured by an engagement score (e.g., generated by the web server 110 and/or the engagement server 112). The calculation and ranking of the engagement score allows for the identification of highly engaged users as well as those user activities that may be most closely correlated with a business objective being met (when compared to other available activities on the web site). This information may be used to redirect product and service offerings, redesign the web site interface, and/or focus strategic development. Further, a customer engagement program may be provided to further encourage engagement, and/or provide additional services to encourage the user of the consumer device 102 to further engage and provide opportunities for value creation and/or revenue generation.

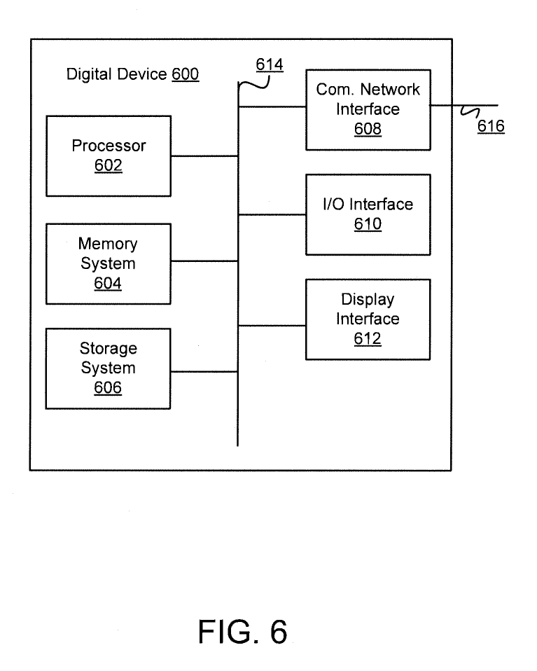

Consumer devices 102, 104 and 106 are digital devices. A digital device is any device that comprises memory and a processor. Digital devices are further described in FIG. 6. The consumer devices 102, 104, and 106 may be any kind of digital device that may be used to interact with a web page from the web server 110 including, but not limited to a desktop computer, laptop, notebook, media tablet, smartphone, personal digital assistant, and ebook reader.

The user of a consumer device 102, for example, may interact and/or engage with a web site on the web server 110. In one example, the web server 110 is a search engine that provides an interface to search for one or more web pages based on keyword search terms provided by the user. The web server 110 may also provide content that the user may browse. The content may attract users and provide another vector in which sponsored links may be offered to the user.

Any number of the consumer devices 102, 104, and/or 106 may be associated with one or more engagement scores that may indicate the likelihood of the users of consumer devices 102, 104, and/or 106 to provide value and/or generate revenue. In one example, the owner of the web site published by the web server 110 may segment users based on the engagement score. Once the users are segmented, the user activities associated with different user segments may indicate the likelihood of the user of a segment to either provide value (e.g., generate content, become a recurring contributor, or invite others) or provide revenue (e.g., click on a sponsored link, purchase offered products or services, and/or purchase advertised products).

Users may be identified and associated with the engagement score. In some embodiments, a user of consumer device 102 associated with a high engagement score indicates a high probability that the user will provide greater value for the web site. Further, in various embodiments, the functionality of one or more web pages on the web server 110 may recognize the consumer device 102, retrieve an engagement score associated with the consumer device 102, and provide targeted advertising (e.g., a message indicating a discount to select consumers) or enhanced services to the user to further encourage engagement, value creation, and/or revenue generation.

Based on the engagement scores, the owner of the web site may make changes to encourage and attract users associated with a desired user segment. After changes have been made (e.g., a user of a desired user segment is notified that they have qualified for “free shipping”), engagement scores may be recalculated based on user frequency and user activities over another predetermined time period. This process may continue as refinements are made to attract the user's most likely to contribute to the business objectives of the web site.

Similarly, based on the engagement scores and/or correlations with business objectives, the owner of the web site may make changes to encourage one or more actions correlated with business objectives. For example, the one or more web pages of a web site may be redesigned to encourage users to perform actions likely to result in business value. Those skilled in the art will appreciate that a business may take many actions to encourage valuable users and/or actions based on engagement scores to achieve business objectives.

The communication network 108 may be any network that allows digital devices to communicate. The communication network 108 may be the Internet and/or include LAN and WANs. The communication network 108 may support wireless and/or wired communication.

The web server 110 is a digital device that is configured to provide services to one or more consumer devices 102, 104, and/or 106. The web server 110 may, in some embodiments, publish one or more web pages and/or web sites. In one example, the owner of a web site may contract with an owner of a web server 110 to publish the web site online.

The owner of the web server 110 typically has one or more business objectives in providing the information. In one example, an objective may be to build a network of interacting consumers (e.g., Twitter or Facebook). In another example, an objective is to provide and have the user click on a sponsored link. In yet another example, an objective may be for the user to purchase a good or service either from the web server 110 or with an associated provider.

In order to determine the quality of the user's engagement, the web server 110 and/or the engagement server 112 may calculate one or more engagement scores. The engagement scores may be closely correlated with the business objectives so as to provide a meaningful and quantitative metric that allow a business owner (e.g., the owner of the web site) to identify user segments and significant user actions that are closely tied to business objectives.

The optional engagement server 112 is a digital device that may calculate engagement scores of one or more users and/or consumer devices 102, 104, and 106 for the operator of the web site published on the web server 110. In various embodiments, the engagement server 112 may track user frequency and user action on the web site. In other embodiments, the engagement server may calculate the engagement score and provide the results to the owner of the web site. Those skilled in the art will appreciate that the web server 110 may provide all or some of these functions. Similarly, the engagement server 112 may also work in conjunction with the web server 110 and provide all or some of the services of calculating the engagement of the user device(s).

Although consumer devices 102, 104, and 106 are depicted similarly, those skilled in the art will appreciate that each consumer device may be different or the same as any other consumer device. Further, although three consumer devices 102, 104, and 106 are depicted in FIG. 1, there may be any number of consumer devices. Similarly, although a single communication network 108, web server 110, and engagement server 112 are depicted, those skilled in the art will appreciate that there may be any number of communication networks 108, web servers 110, and engagement servers 112.

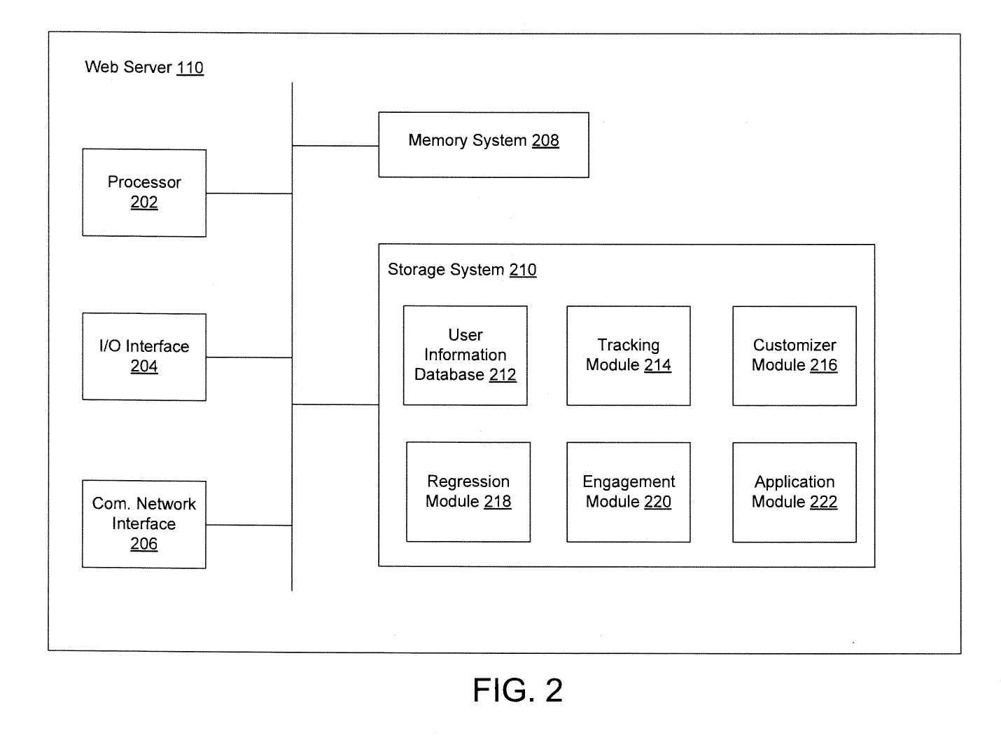

FIG. 2 is a block diagram of an exemplary engagement server 112. In exemplary embodiments, the engagement server 112 computes and ranks the engagement score based, at least in part, on consumer initiated actions. In some embodiments, the engagement server 112 is a server (or any digital device) executing Nitro™. In FIG. 2, the engagement server 112 comprises a processor 202, input/output (I/O) interface 204, a communication network interface 206, a memory system 208, and a storage system 210. The processor 202 may comprise any processor or combination of processors with one or more cores. The I/O interface 204 may comprise interfaces for various I/O devices such as, for example, a keyboard, mouse, and display device. The exemplary communication network interface 206 is configured to allow the engagement server 112 to communication with the communication network 108 (see FIG. 1). The memory system 208 may be any kind of memory including RAM, ROM, or flash. The storage system 210 may comprise various databases, or storage, such as, for example, user information database 212 which may store user information, user frequencies, user activities, business objectives, and/or engagement scores.

The storage system 210 comprises a plurality of modules utilized by embodiments of the present invention to generate an engagement score. A module may be hardware, software (e.g., including instructions executable by a processor), or a combination of both. In one embodiment, the storage system 210 comprises a user information database 212, a tracking module 214, a customizer module 216, a regression module 218, an engagement module 220, and an application module 222. Alternative embodiments of the engagement server 112 and/or the storage system 210 may comprise more, less, or functionally equivalent components and modules.

The user information database 212 is any data structure that is configured to store information such as tracking information, correlation values, engagement values (e.g., engagement scores), user frequencies, visit frequencies, and the like. In some embodiments, information may be collected in any number of storage devices and/or different logical volumes with one or more servers. Tracking information, correlation values, engagement values, user frequencies, and visit frequencies are further discussed herein.

The tracking module 214 may be configured to track, per user, a user frequency associated with different user action categories over a predetermine period of time. The user frequency associated with a user action category is the number of times a user performs one or more activities associated with the user action category over a predetermined time. User action categories may include, for example, consume content, share content, register/login, provide content, share information, making a purchase, call-to-action, and participate in a game. Each category may be associated with any number of actions. For example, the share content category may be associated with actions by a user emailing a story to another user as well as adding another user as a friend on a social web site. The call-to-action category may be associated with actions by a user to encourage others to interact with the web site or perform specific functions. Those skilled in the art will appreciate that there may be any number of user action categories. For example, a user action category may also include providing invitations for products or services of the web site.

In some embodiments, the tracking module 214 may store user frequency information (e.g., user frequency in different user action categories) per user in the user information database 212. In one example, the user frequency information may be represented as a vector (e.g., an array) with a different value for user frequency associated with different user action categories.

In one example, when a user views a web page, the tracking module 214 may increment a user frequency counter associated with the consume content user action category. When the user sends a business article on the web site to a friend, the tracking module 214 may increment a user frequency counter associated with the share content user action category. When a user logs into a web site (e.g., registers or logs into a mail account), the tracking module 214 may increment a user frequency counter associated with the log in/register user action category. Further, when a user writes an article or blog on the web site, the tracking module 214 may increment a user frequency counter associated with the provide content user action category. The share user information category may be associated with actions such as create and update an address book or post a link on a social network. Those skilled in the art will appreciate that many activities may be associated with these categories. Further, user frequency associated with other categories that identify the different types of user activities may also be tracked by the tracking module 214.

Those skilled in the art will appreciate that a single activity may trigger an increment of user frequency in multiple categories. For example, in some embodiments, a user may log into a web site to access premium content. In this example, the tracking module 214 may increment a user frequency counter for the consume content category as well as the user frequency counter for the log in/register category. In other embodiments, the tracking module 214 may be configured to only increment a single user frequency counter associated with a single user action category.

In some embodiments, the web site may be configured to perform all or part of the tracking. For example, a widget operated as part of the web site may perform all or part of the tracking function. The widget may comprise the user action categories as well as a list of user activities which are associated with each category. When a user access a web page and performs an action, the widget may increment the correct user frequency counter(s). This information may then be used to generate engagement scores. Further, the widgets may be used to communicate with users based on the engagement scores, user segment, activity, or the like as a part of the iterative process described herein.

The predetermined period of time may be any length of time. In some embodiments, the predetermined period of time is thirty days, sixty days, or within a range from thirty to sixty days. In one example, the tracking module 214 determines user frequency by calculating user activities with one or more web pages over thirty days. Those skilled in the art will appreciate that the user frequency may not be limited to users, but may be based on IP address, MAC address, consumer device 102 identifier, or any other identifier. Further, the user frequency may track a single user (e.g., via a user name or other user identifier) or a group of users (e.g., a family, organization, or department).

In some embodiments, the tracking module 214 may limit the number of user frequency increments over a limited time duration. For example, one or more visits to a web site during a thirty minute time duration may count as a single user frequency increment in the consume content user action category. As a result, the tracking module 214 may have a lower user frequency for a user that visits a web site and repeatedly reloads a web page over five minutes (e.g., waiting for the results of a sporting event or breaking news). The tracking module 214 may count a high user frequency for users who engage with a web site throughout a day.

The customizer module 216 may be configured to receive business objectives as well as correlation values from the web server 110 and/or the owner or manager of the web site on the web server 110. In various embodiments, the owner of a web site identifies the business objectives and correlates the business objectives with a visit frequency. The visit frequency is the number of visits of a user or group of users during the predetermined period. The correlation may be represented as a correlative value.

In some embodiments, the owner of a web site may correlate business objectives with different user action categories. For example, a web site objective may be for users to click on sponsored links to generate revenue. The owner of the web site may then review the different categories, over time, to determine what kinds of activities (e.g., categories of activities) are likely to result in the web site objective being met. In one example, the business owner may recognize that a user that consumes content thirty times (e.g., user frequency) during a predetermined period of time are only 2.5% likely to click on a sponsored link, however, users that share content 5 times during that same time may be 8.8% likely. The business owner may identify one or more business objectives and correlate the probability of success for each objective given activities in the user action categories. This information may be provided to the customizer module 216.

Those skilled in the art will appreciate that the correlation value may be based on visit frequency and/or a single user action category (e.g., a user that consumes content 7 times during the predetermined time has a correlative value of 4.2% of meeting a web site objective). The correlation values may also be based on multiple actions that are associated with different categories. For example, user A may be 2.8% likely to click a link after sharing content 5 times during the predetermined period, but is 10.9% likely to click a link after sharing content 7 times during that same predetermined period. Further correlations may be made in combination of activities such as a user's likelihood to click on a link may be higher (e.g., 14%) if the user consumes content 8 times, logs in 4 times, and shares content 3 times during the predetermined period. In some embodiments, the customizer module 216 may take the correlative values of actions over multiple categories and determine the impact on a single category (e.g., increase the weight of category X if a number of activities associated with category X in combination with a number of activities associated with category Y increases the possibility of a business objective being met).

Those skilled in the art will appreciate that, although the tracking module 214 may track individual or group behavior, the correlation values may be based on visit frequency and/or all user activities and their relationship with achieving the web site objective(s).

In various embodiments, the business owner may simply provide data regarding visit frequency and/or user activities over the predetermined period of time as well as information regarding what business objectives were met during that time. For example, the business owner may track all user activities as well as all information related to a user that clicks on sponsored links. The customizer module 216 may associate the user visits with business objectives and/or associate user activities with the different user action categories and analyze what activities and action categories are likely to result in a click on a sponsored link. The customizer module 216 may then calculate the correlation value between a user visit and/or an action category and the likelihood of the business objective being met.

In some embodiments, correlations are measured from 1 to −1, with 1 indicating 100% correlation, 0 indicating no relation, and −1 being no correlation. Those skilled in the art will appreciate that correlations may be measured any number of ways and be represented in any number of values.

The regression module 218 may be configured to perform a regression analysis on the user frequency information and the user action categories. In various embodiments, the regression module 218 uses user action categories (e.g., the consume content category, share content category, log in/register category, and the share content category) as independent variables and the user frequency associated with each user action category as dependent variables. The regression module 218 may generate a regression score per user that represents that user's frequency of activities by user action category over the predetermined time.

In an example, the regression analysis may be as follows:

y=b₀+b₁x₁+b₂x₂+b₃x₃+ . . . +bₙxₙ

where y is the regression score, b₀ maybe an estimated constant, bᵢ is the coefficient (e.g., user frequency) and xᵢ is the independent (explanatory variables). For example, x₁ may be associated with acts of content consumption, x₂ may be associated with acts of content sharing, x₃ may be associated with acts of log in/registration, and x₄ may be associated with acts of content providing.

In some embodiments, the coefficients (e.g., b₀, b₁, b₂, b₃, . . . bₙ) of the regression analysis may be normalized and/or scaled. In one example, when the coefficients fall within a possible range of values, a new coefficient may be assigned to that independent variable. Further, in various embodiments, the coefficients for each category may be a function of the user frequency for a particular user action category divided by the sum of user frequencies (for that user) over all user action categories. In one example, after division, the coefficient for the consume content category may be equal to 0.001385. That coefficient may then be normalized such that when the coefficient falls between 0.0013 and 0.0014, a value of 30 points is assigned as that coefficient. Another range may result in an assignment of 0 points or negative points, for example. Those skilled in the art will appreciate that the scaling and/or normalization of coefficients is optional and may be performed any number of ways.

The regression module 218 may store the regression scores in the user information database 212. The regression score, similar to the user frequency, may not be limited to users, but may be based on IP address, MAC address, consumer device 102 identifier, or any other identifier. Further, the user frequency may track a single user or a group of users.

Those skilled in the art will appreciate that the regression analysis may be linear regression analysis. In other embodiments, the regression analysis may be nonlinear.

The engagement module 220 may be configured to calculate the engagement score. In some embodiments, the engagement module 220 weighs different user action categories (i.e., weighs different coefficients of different independent variables) of the regression analysis from the regression module 218 based on the correlation values from the customizer module 216. For example, the objective correlation from the customizer module 216 may indicate that there is a 0.35% likelihood that a user who logs onto the web site X times will meet a business objective. The engagement module 220 may multiply the coefficient of the log in/register user action category of the regression analysis with the correlation value (i.e., 0.35%) if the user logs in X times. The result may be a weighing of the different correlation values.

The engagement module 220 may generate the engagement score. The engagement score (e.g., an absolute value) may be per user or per user group. The engagement score may represent the quality of engagement of that user and the user's likelihood to help the business owner achieve one or more business objectives.

In some embodiments, the engagement module 220 calculates and ranks a relative value of a coefficient of a first user action category to a coefficient of a second user action category (and so on) to determine the strength of a user activity impacting the business objective. As a result, based on the relative value, a business owner will be able to identify those activities most likely to produce results that meet business objectives. For example, the uploading of a video may drive greater business value than the action of reading a review. As a result of the absolute and relative values, the business owner may create targeted product and service strategies to encourage the right activities from the right users.

Those skilled in the art will appreciate that the process of correlating activities with business objectives may be helpful to focus on those goods and services the provide value to the business. Further, the individual engagement scores may help the business owner to identify the types of users as well as the types of user behavior that are likely to result in a business objective being met. As a result the business owner may change the web site, add content, run advertisements focused on the users that produce the most value to the business, target advertising, and provide services that are directed to producing results.

In various embodiments, an ecommerce site (e.g., an ecommerce web site) may make money by a user purchasing a product or service online. As such, it is the site operator's interest to increase the conversion rate (i.e., the number of purchases per visitor). Based on the engagement score, the web site operator may discover that users who perform a particular action, such as read a product review, are more likely to convert. Based on that information, the ecommerce site may launch a campaign to encourage users to write more product reviews in order to ultimately increase sales.

In some embodiments, the application module 222 is configured to apply engagement insights and user segment information to marketing programs, service features, and/or product features. For example, the application module 222 may be configured to target advertising based, at least in part, on the engagement score. The web site operator may discover, based on the engagement scores and user segmentation in this example, that male users between the ages of 14-34 are most likely to click on an advertisement. The application module 222 may then direct advertisements, messaging, products, and services that may most appeal to that age demographic.

In various embodiments, the application module 222 may identify users through cookies, log in information, or other identifiers. The application module 222 may then retrieve an engagement score from the user information database 212 to determine the user's level of engagement. If the user is associated with a positive user segment, the application module 222 may target advertisements on that user's demographics and/or based on previously stored information.

The application module 222 may also respond to users in real time based on the engagement scores and/or user activities. In one example, after engagement scores have been calculated, a user who accesses a web page may be identified and their engagement score retrieved. Based on the engagement score, the application module 222 may provide the user with a message, special services, or content as a reward and/or to encourage the user to perform actions that meet business objectives (e.g., make purchases). As a result, the user's engagement score may increase as the process continues through multiple iterations. In another example, after user actions have been ranked, the application module 222 may detect user actions that are more valuable than others and provide additional content or messages (e.g., notify the user that free shipping on new products is available after the user reviews a previously purchased product).

Those skilled in the art will appreciate that embodiments discussed herein are not limited to web sites but may include any information, web page, or plurality of web pages available over a network. For example, the tracking module 214 may track the number of visits by a user to a web page or a document from a plurality of documents on a server.

In various embodiments, as discussed herein, this process is iterative. A business may take measurements to generate an engagement score, make changes to products and services to target user segments and/or encourage actions correlated with business objectives, and take new measurements. By calculating new engagement scores, a business may further clarify and identify those users and actions that are most likely to generate value for the business. Product and service strategies may, as a result, be refined to focus on maximizing return.

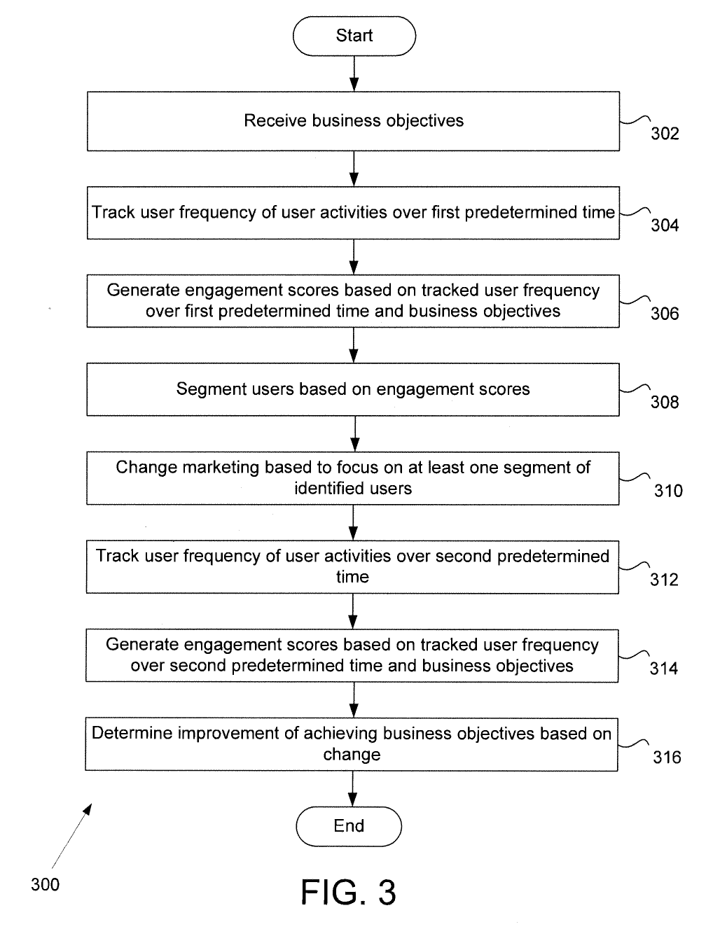

FIG. 3 is a flowchart of an exemplary method 300 for increasing value based on user engagement. In various embodiments, for example, a brand-named business may improve their traditional brand metrics, such as awareness, purchase intent, likelihood to recommend, and favorability by increasing users' engagement, because highly engaged users who have the brand in mind and have frequent interaction with the brand usually result in higher scores on the above measures vs. traditional banner advertising; by the same token, an owner of a web site may increase the value and/or revenue of a web site by measuring user engagement via engagement scores and make changes to the user experience to encourage engagement and further increase value and/or revenue.

In step 302, the customizer module 216 receives business objectives. The objectives may be the goals of the web site to generate value and/or revenue. Step 302 may be performed at any time.

In step 304, the tracking module 214 tracks user frequency of activities associated with a plurality of user action categories over a first predetermined time. For example, the tracking module 214 may comprise a counter associated with each user action category. When a user performs an activity associated with the user action category, the tracking module 214 may increment the respective counter. Those skilled in the art will appreciate that the tracking module 214 may be on the web server 110, in some embodiments. The user action categories may comprise content consumption, content sharing, log in/register, and content providing. There may be any number of categories.

In step 306, after the first predetermined time, the engagement module 220 generates engagement scores based on the tracked user frequency over the first predetermined time and the business objectives. For example, a regression analysis may be performed on the user frequencies across different user activities as previously discussed. Once business objectives are correlated with visit frequency and the coefficients of the regression analysis weighed by the value of correlation, then the engagement score may be calculated. Each user or group of users may be associated with a different engagement score.

In step 308, the web site operator segments users based on the engagement scores. Those most likely to provide value or generate revenue for the web site may be identified and grouped. Demographic and personal data (e.g., from previous registration) may be used to further identify the types of users most apt to contribute to the web site's business objectives (e.g., those users with high engagement scores). Those skilled in the art will appreciate that the any quantifiable measurement may be used. For example, in some embodiments, a low score may indicate increased engagement and a high score indicates less engagement.

In some embodiments, once the users are segmented, the user activities of those with the highest engagement scores may be analyzed. The web site operator may then make changes to encourage those activities and to encourage more users to perform those activities that lead to increased likelihood that a user will contribute to value or revenue of the web site.

In step 310, the web site operator changes marketing based on at least one segment of identified users. In one example, the web server 110 may direct email or other advertisements directly to the users of the user segment (e.g., via an email address provided by the user during registration). The advertisement may direct the user to further engage with the web site and/or web site partners. In another example, the web site operator may change advertisements on the web pages so that the advertisements are directed to the demographics or interest of the user segments most likely to contribute to the web site's business objectives.

Once the changes are made, engagement scores may be re-calculated and business objectives measured to evaluate whether business objectives are being met (e.g., value or revenue is being increased). In step 312, the tracking module 212 may track user frequency of activities associated with the user action categories over a second predetermined period of time. The second predetermined period of time may be of the same duration as the first predetermined period of time (e.g., 30 days).

In step 314, the engagement module 220 generates engagement scores based on tracked user frequency over the second predetermined time and business objectives. The engagement module 220 may conduct the same process as discussed herein in calculating the engagement scores, however, in this step, the engagement module 220 may use the newly tracked data over the second predetermined period of time.

In step 316, the web site operator and/or the engagement module 220 may evaluate any improvement of meeting business objectives based on the changes in step 310. Those skilled in the art will appreciate that the web site operator may make any changes to the marketing, products, and/or services offered by the web site an then measure the effect of the changes by measuring when business objectives have been met (e.g., accounting for revenue) and calculating user engagement over a new predetermined time period. This process may continue to be iterative thereby allowing the web site operator to continue to make any number of changes, measure the result as well as the affect on engaged users, and then continue to focus changes to increase return.

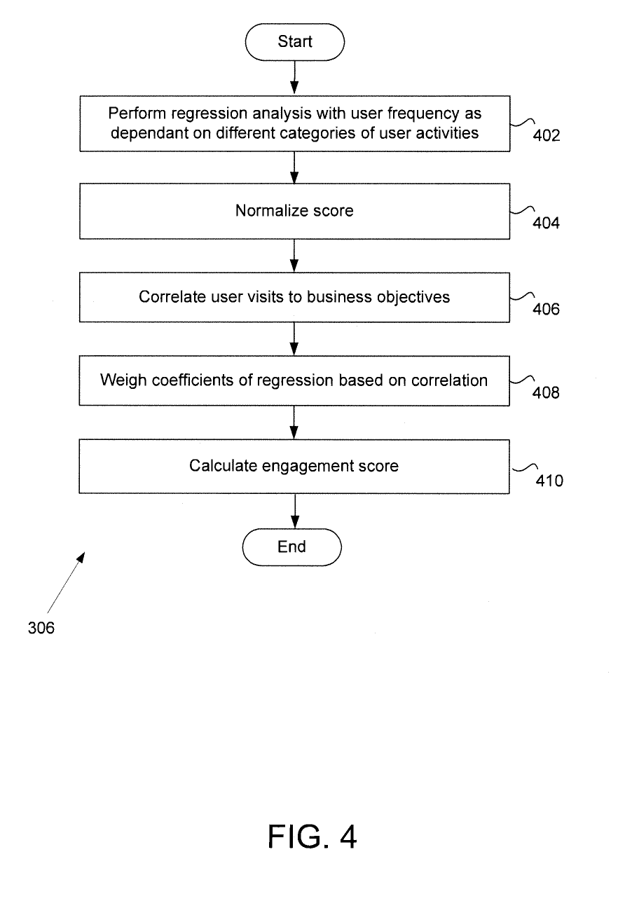

FIG. 4 is a flowchart of an exemplary method 306 for calculating an engagement score. In step 402, the regression module 218 performs regression analysis with user frequency as dependent (e.g., a dependant variable) on different user action categories (e.g., independent variables). For example, the regression module 218 may perform a linear regression whereby user frequency is a coefficient and represents the number of times a user performs an action associated with the user action category over a predetermined period of time.

In optional step 404, the regression module 218 normalizes the coefficients of the regression analysis. In one example, coefficients that fall into predetermined ranges are assigned a new value. These new values may then be used in the regression analysis.

In step 406, the customizer module 216 correlates visit frequency to business objectives. In some embodiments, the web site operator provides correlation values based on the frequency of user visits over a predetermined period of time and the likelihood that the user will contribute to the business objectives. Further, in various embodiments, the web site operator provides correlation values based on user action over the predetermined time, and the likelihood that the user with contribute to the business objectives. In other embodiments, the customizer module 216 calculates the correlation values.

In step 408, the engagement module 220 weighs coefficients of the regression analysis based on the correlation values from the customizer module 216. In step 410, the engagement module 220 calculates the engagement score based on the regression analysis and the weighted, normalized coefficients.

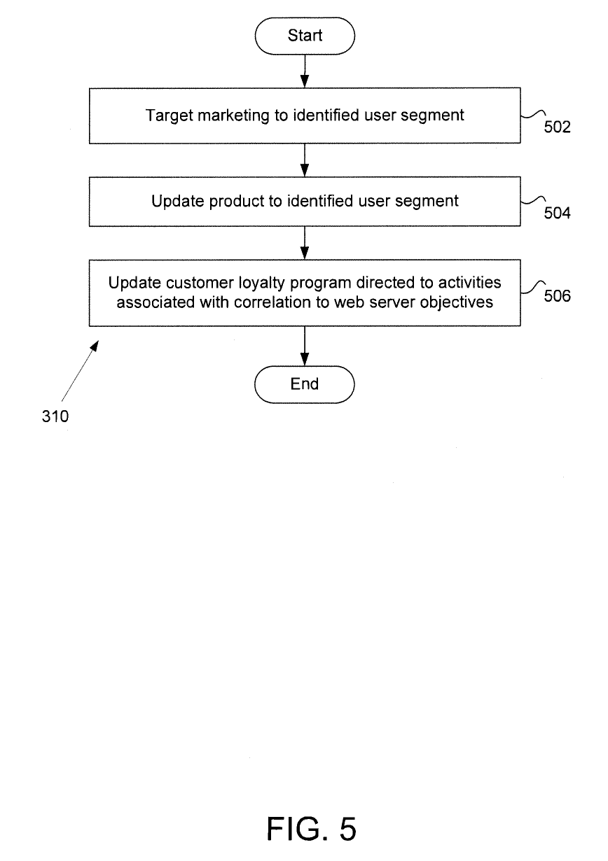

FIG. 5 is a flowchart of an exemplary method 310 for improving revenue and value based, at least in part, on the engagement score. In step 502, the application module 222 may target messages and/or advertisements to users associated with a user segment that has high engagement scores. The application module 222 may also detect when the message or advertisement is activated (e.g., read or clicked on) and detect actions that either fulfill the business objective (e.g., a purchase) or lead to actions where a business objective is likely to be met.

For example, the advertisements may encourage the user to visit the web site and perform particular actions that have been found to be strongly correlated with the generation of value and/or revenue of the web site. The application module 222 may then detect if the user performs those actions (or related actions) and provide further messages (e.g., special offers), content, and/or services.

In another example, advertisements on web pages of the web site may be updated and altered to appeal to users associated with user segments with higher engagement scores. Further, advertisements may be directed to other web sites and other web pages that advertise products and services of to further encourage value and/or revenue generation. Those skilled in the art will appreciate that any number of advertisement campaigns and marketing vectors may be used based on engagement scores and/or relative value of user actions.

Further, in some embodiments, when a user visits the web site, the application module 222 may identify the user (e.g., through a cookie, log in, username, MAC address, IP address or other identifier), retrieve the user's engagement score for the user information database 212, and, based at least in part on the engagement score, select one or more advertisements to present to the user through a web page. For example, if the engagement score is low, the application module 222 may select advertisements that market the web site to encourage the user to perform activities that are more closely correlated with business objectives (e.g., generate value, and/or generate revenue for the web site).

In step 504, the web site operator may update a product and/or service based on the identified user segment and/or desired user action. In some embodiments, the web site operator may choose to carry or offer different products that appeal to users most apt to provide value and/or revenue. For example, the application module 222 may identify a segment of users with the highest engagement scores as being users between the ages of 44-52. The web site operator may expand offerings (e.g., products or services) and redesign the web site to attract more of these types of users. By encouraging the users, further value and/or revenue may be generated. Similarly, actions that are more closely correlated with business objectives may also be encourage by redesigning the website to highlight select functions.

In step 506, the web site operator may modify customer engagement programs directed to activities associated with correlation values to business objectives. In the past, customer loyalty programs reward past behavior. Customer engagement programs, however, may encourage future behavior by encourage actions that are more closely related to business objectives.

FIG. 6 is a block diagram of a digital device 600 in which various embodiments may be practiced. Any of the consumer devices 102, 104, and 105, the web server 110, and the engagement server 112 may be an instance of the digital device 600. The digital device 600 comprises a bus 614 in communication with a processor 602, a memory system 604, a storage system 606, a communication network interface 608 communicatively coupled to a communication channel 616, an input/output device 610, and a display interface 612. The processor 602 is configured to execute executable instructions (e.g., programs). In some embodiments, the processor 602 comprises circuitry or any processor capable of processing the executable instructions.

The memory system 604 stores data. Some examples of memory system 604 include storage devices, such as RAM, ROM, RAM cache, virtual memory, etc. In various embodiments, working data is stored within the memory system 604. The data within the memory system 604 may be cleared or ultimately transferred to the storage system 606. The storage system 606 includes any storage configured to retrieve and store data. Some examples of the storage system 606 include flash drives, hard drives, optical drives, and/or magnetic tape. Each of the memory system 604 and the storage system 606 comprises a computer-readable medium, which stores instructions or programs executable by processor 602.

The communication network interface (com. network interface) 608 may be coupled to a network via the communication channel 616. The communication network interface 608 may support communication over an Ethernet connection, a serial connection, a parallel connection, and/or an ATA connection. The communication network interface 608 may also support wireless communication (e.g., 802.11 a/b/g/n, WiMax, LTE, WiFi). It will be apparent to those skilled in the art that the communication network interface 608 can support many wired and wireless standards.

The input/output device 610 is any device such an interface that receives inputs data (e.g., via mouse and keyboard). The display interface 612 is an interface that outputs data (e.g., to a speaker or display). Those skilled in the art will appreciate that the storage system 606, input/output device 610, and display interface 612 may be optional.

The above-described functions and components can be comprised of instructions that are stored on a storage medium (e.g., a computer readable storage medium). The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

1. A method comprising:
receiving business objectives of a branded web site or online publisher on a server;
tracking user frequency and user activities for a predetermine time;
computing and ranking engagement scores with the web site based on the tracked user frequency as a function of user action categories for the predetermined time and business objectives, the user action categories being associated with the user activities;
segmenting users based the engagement scores; and
directing an advertisement to a user of at least one user segment.

2. The method of claim 1, wherein the at least one segment is of a plurality of user segments, having a higher correlation with business objectives than other user segments of the plurality of user segments.

3. The method of claim 1, wherein tracking user frequency and user activities comprises tracking a frequency of user activities related to the user action categories for the predetermined period of time.

4. The method of claim 3, wherein the user action categories include a consume content category, a log in/register category, a provide content category, a share information category, and a making a purchase or call-to-action category.

5. The method of claim 3, wherein generating engagement scores comprises performing regression analysis with tracked user frequency being a dependent variable and the different user action categories being different independent variables.

6. The method of claim 5, wherein generating engagement scores further comprises ranking regression coefficients for each of the user action categories.

7. The method of claim 5, wherein generating engagement scores further comprises correlating visit frequencies to the business objectives.

8. The method claim 7, wherein generating engagement scores further comprises weighing coefficients of the regression analysis based on the correlation to calculate engagement scores.

9. The method of claim 1, wherein the predetermined time ranges from 30 to 180 days.

10. The method of claim 1, further comprising customizing a customer engagement program directed to at least one user segment based on engagement scores.

11. A system comprising:
an input/output interface configured to receive business objectives of a web site on a web server;
a tracking module configured to track user frequency and user activities for a predetermine time;
an engagement module configured to compute and rank engagement scores with the web site based on tracked user frequency as a function of user action categories for the predetermined time and business objectives, the user action categories being associated with the user activities;
a customizer module configured to segment users based on engagement scores; and
an application module configured to direct an advertisement to a user of at least one user segment.

12. The system of claim 11, wherein the at least one segment is of a plurality of user segments, the at least one segment having a higher correlation with business objectives than other user segments of the plurality of user segments.

13. The system of claim 11, wherein the tracking module configured to track user frequency of user activities comprises the tracking module configured to track a frequency of user activities related to the use action categories for the predetermined period of time.

14. The system of claim 13, the user action categories include a consume content category, a log in/register category. a provide content category, a share content category, and a making a purchase or call-to-action category.

15. The system of claim 13, wherein the engagement module configured to generate engagement scores comprises the engagement module configured to perform regression analysis with tracked user frequency being a dependent variable and the different user action categories being different independent variables.

16. The system of claim 15, wherein the engagement module configured to calculate and rank engagement scores comprises the engagement module further configured to rank regression coefficients for each of the user action categories.

17. The system of claim 15, wherein the engagement module configured to calculate and rank engagement scores comprises the engagement module further configured to correlate user visit frequencies to the business objectives.

18. The system of claim 17, wherein the engagement module configured to generate engagement scores comprises the engagement module further configured to weigh coefficients of the regression analysis based on the correlation to calculate engagement scores.

19. The system of claim 11, wherein the predetermined time ranges from 30 to 180 days.

20. The system of claim 11, wherein the engagement module configured to calculate and rank engagement scores comprises the engagement module further configured to customize a customer engagement program directed to at least one user segment based on engagement scores.

21. Computer readable media comprising executable instructions, the instructions being executable by a processor to perform a method, the method comprising:
receiving business objectives of a web site on a server;
tracking user frequency and user activities for a predetermine time;
computing and ranking engagement scores with the web site based on tracked user frequency as a function of user action categories for the predetermined time and business objectives, the user action categories being associated with the user activities;
segmenting users based the engagement scores; and
directing an advertisement to a user of at least one user segment.
